(19) United States
(12) Patent Application Publication
(10) Pub. No.: US 2026/0130371 A1
(43) Pub. Date: May 14, 2026

(54) COMPOSITION FOR PROMOTING EARLY HARVEST OF RICE SEEDS, PREPARATION METHOD AND APPLICATION THEREOF

(71) Applicant: AGRO-BIOLOGICAL GENE RESEARCH CENTER OF GAAS, GUANGZHOU (CN)

(72) Inventors: JUN LIU, GUANGZHOU (CN); JIADONG GAO, GUANGZHOU (CN); HUA FU, GUANGZHOU (CN); YOUSHENG ZHANG, GUANGZHOU (CN); AIMIN LIU, GUANGZHOU (CN)

(73) Assignee: AGRO-BIOLOGICAL GENE RESEARCH CENTER OF GAAS, GUANGZHOU (CN)

(21) Appl. No.: 18/843,710

(22) PCT Filed: Mar. 7, 2023
(86) PCT No.: PCT/CN2023/079958

§ 371 Date: Sep. 4, 2024

(30) Foreign Application Priority Data
Mar. 9, 2022 (CN) 202210226487.X

(51) Int. Cl. A01N 43/16; A01G 7/06; A01G 22/22; A01N 31/16; A01N 43/08; A01N 47/44; A01P 21/00

(52) U.S. Cl. CPC A01N 43/16; A01G 7/06; A01G 22/22; A01N 31/16; A01N 43/08; A01N 47/44; A01P 21/00

(57) ABSTRACT

The present invention belongs to the field of rice seeds and discloses a composition for promoting the early harvest of rice seeds, its preparation method, and application. The composition is made from the following raw materials in mass percentage: Dihydromyricetin Extract 61.50% to 63.50%, Resveratrol Extract 6.00% to 9.00%, Vitamin C 12.00% to 16.00%, Agricultural Streptomycin Sulfate 12.00% to 16.00%. The composition is reasonably formulated, utilizing the respective effects of chemical raw materials and natural plant extracts to regulate the seed harvest period. Experimental verification has shown that the composition has a significant effect on promoting the early harvest of rice seeds. The preparation process is simple, and the composition is easy to use, providing an ideal product for promoting the early harvest of rice seeds.

### TECHNICAL FIELD

The present invention relates to the field of rice seeds and particularly relates to a composition for promoting the early harvest of rice seeds, its preparation method, and application.

### BACKGROUND

Rice seeds are the most fundamental and irreplaceable production material in rice cultivation. The quality of rice seeds determines the success or failure of field production. Among the factors that influence seed quality, timely maturity and harvest of seeds are critical. Generally, the harvest time of crop seeds is positively correlated with the germination rate, vigor, and subsequent seedling robustness and growth status. Therefore, timely harvesting of seeds is a basic requirement in seed production. In recent years, with the expansion of seed production scale, changes in seed production methods, and frequent extreme weather conditions, situations often arise where seeds need to be harvested under unfavorable weather conditions or large areas of seeds need to be harvested simultaneously. Harvesting seeds in bad weather poses inconveniences for the harvesting process and may lead to seed deterioration due to stacking, mildew, and contamination, especially in rainy conditions, significantly affecting seed quality and causing direct losses to field production. Additionally, the simultaneous harvest of large areas of seeds creates difficulties in arranging harvesting machinery and personnel. Consequently, staggered and timely harvesting of seeds has long been a goal for seed producers. With the improved accuracy of weather forecasting, the development of products that can regulate the harvest time of rice seeds has become a hot topic in the rice seed production market. However, there has been no breakthrough in such technology.

### SUMMARY

To address the deficiencies and shortcomings of the prior art, the primary objective of the present invention is to provide a composition for promoting the early harvest of rice seeds, which can facilitate the early harvest of rice seeds, allowing them to be harvested at an appropriate time under favorable weather conditions.

Another objective of the present invention is to provide the preparation method for the aforementioned composition.

A further objective of the present invention is to provide the application of the aforementioned composition in promoting the early harvest of rice seeds.

The objectives of the present invention are achieved through the following technical solutions:

A composition for promoting the early harvest of rice seeds, made from the following raw materials in mass percentage:
dihydromyricetin extract: 61.50% to 63.50%
resveratrol extract: 6.00% to 9.00%
vitamin c: 12.00% to 16.00%
agricultural streptomycin sulfate: 12.00% to 16.00%

Preferably, the composition is made from the following raw materials in mass percentage:
dihydromyricetin extract: 63.00%
resveratrol extract: 7.00%
vitamin c: 15.00%
agricultural streptomycin sulfate: 15.00%

The dihydromyricetin extract refers to a product obtained by extracting and purifying ampelopsis grossedentata, with a dihydromyricetin content of ≥55%.

The resveratrol extract refers to a product obtained by extracting and purifying grape skins and seeds, with a resveratrol content of ≥20%.

The vitamin c used contains more than 95% Vitamin C.

The agricultural streptomycin sulfate used contains more than 70% Streptomycin Sulfate.

The dihydromyricetin extract is prepared by the following steps: Fresh stems and leaves of Ampelopsis grossedentata are dried at a temperature of 35° C. to 45° C. to obtain dried Ampelopsis grossedentata raw material. The dried raw material is extracted using an ethanol extraction method to obtain an extract solution, which is concentrated to 30% to 40% of its original volume. The concentrated solution is then placed in a −4° C. cold storage for 24 hours to allow precipitation. The precipitate at the bottom of the dried liquid is the Dihydromyricetin Extract. The ethanol extraction method uses a ratio of 1:10 to 12 between the dried raw material and ethanol, with an ethanol concentration of 85% to 95%. The Ampelopsis grossedentata is sourced from Guangdong, Guangxi, Hunan, Hubei, or Jiangxi provinces. Preferably, the ethanol concentration is 90%, and the precipitate at the bottom of the dried liquid is dried in an oven at 90° C. to 95° C. The Ampelopsis grossedentata used is preferably from the spring or summer seasons in Zhangjiajie, Hunan province.

The resveratrol extract is prepared by the following steps: Polygonum cuspidatum is used as the raw material, and ethanol with a concentration of 75% (six times the volume of the raw material) is used as the extraction solvent. The extraction is performed at a temperature of 70° C. to 75° C. for 1 hour, followed by ethanol recovery and spray drying of the extract solution to obtain the Resveratrol Extract.

The vitamin C is produced by Zhengzhou Chengwang Chemical Co., Ltd., and the agricultural streptomycin sulfate is produced by Chengdu Puhui Bioengineering Co., Ltd.

The preparation method for the composition for promoting the early harvest of rice seeds includes the following steps: Weigh the raw materials according to the above proportions, place them in a mixing tank, stir evenly, and then package in composite aluminum bags or cans to obtain the composition for promoting the early harvest of rice seeds.

The application of the composition for promoting the early harvest of rice seeds involves the following steps: On the day of artificial pollination of rice seeds, dissolve the composition in water to form a ready-to-use solution with a concentration of 0.1% to 0.3%. Spray the solution onto the rice panicles at a dosage of 50 kg per mu. Depending on the desired seed maturity period, spray 1 to 2 times.

Preferably, if it rains within 24 hours after spraying, a re-spray is required.

The principle of the present invention is as follows:

Dihydromyricetin is the main active ingredient in Ampelopsis grossedentata and has multiple functions, including anti-aging, antioxidant, and promoting balanced cell growth. In the formulation of the present invention, the main function of dihydromyricetin is to promote the activity of peroxidase (POD), catalase (CAT), dehydrogenase, and amylase in the seeds during the development of rice seeds, as well as increase the content of soluble proteins.

Resveratrol is a phytoalexin, antioxidant, and histone modification enzyme with a role in accelerating the transport of assimilates. In this formulation, its main use is for its bactericidal effect, reducing microbial damage, enhancing the stress resistance of seed embryonic cells, and accelerating the transport of assimilates, thereby advancing the seed harvest period.

Vitamin C is a water-soluble strong antioxidant. In the formulation of the present invention, its use is twofold: enhancing the stress resistance and immunity of seeds during development, thereby improving overall seed vigor, and serving as a histone modification enzyme to regulate grain development.

Agricultural streptomycin sulfate is water-soluble and is an antibiotic bactericide. In this formulation, its use is twofold: utilizing its bactericidal effect to reduce mold growth on the panicles during seed development, thus reducing the mold rate of seeds, and serving as a protein synthesis inhibitor to regulate grain development.

Compared to the prior art, the present invention has the following advantages and beneficial effects:

(1) The composition of the present invention is reasonably formulated, utilizing the respective effects of chemical raw materials and natural plant extracts to regulate the seed harvest period. Experimental verification has shown that the composition has a significant effect on promoting the early harvest of rice seeds.

(2) The preparation process is simple, and the composition is easy to use, providing an ideal product for promoting the early harvest of rice seeds.

### DETAILED DESCRIPTION

The present invention will be further described in detail in conjunction with the following examples, but the implementation of the invention is not limited to these examples.

All rice seeds used in the experiment were provided by Hunan Longping High-Tech Seed Industry Co., Ltd.

Method for regulating the harvest period of rice seeds during seed production: After artificial pollination of seed fields (approximately 7 days after spraying “920”), spray the seed harvest period regulator on the panicles and leaves (using water as a control). Sampling begins 10 days after spraying the regulator, and samples are taken every 3 days thereafter. The germination rate, vigor, and other indicators of the samples are tested. The test variety used was Longliangyou 534 from Hunan Longping High-Tech Seed Industry.

Method for measuring the germination vigor of rice seeds: Conducted according to the “Method for Determining Germination Rate of Rice Seeds” (GB/T 3543). The germination vigor is the germination rate recorded on the 4th day after the germination test begins.

Method for measuring the germination rate of rice seeds: Conducted according to the “Method for Determining Germination Rate of Rice Seeds” (GB/T 3543).

$$Germination rate ( \% ) = ( number of germinated seeds / total number of seeds ) \times 100 \% .$$

The result is recorded on the 7th day after the germination test begins.

$$Moldy seed rate ( \% ) = ( number of m oldy seeds / total number of seeds ) \times 100 \% .$$

The sources of raw materials used in the following examples are as follows:

Dihydromyricetin extract is prepared by the following steps: Fresh stems and leaves of Ampelopsis grossedentata are dried at a temperature of 35° C. to 45° C. to obtain dried Ampelopsis grossedentata raw material. The dried raw material is extracted using an ethanol extraction method to obtain an extract solution, which is concentrated to 30% to 40% of its original volume. The concentrated solution is then placed in a −4° C. cold storage for 24 hours to allow precipitation. The precipitate at the bottom of the dried liquid is the dihydromyricetin extract. The ethanol extraction method uses a ratio of 1:10 to 12 between the dried raw material and ethanol, with an ethanol concentration of 85% to 95%, preferably 90%. The Ampelopsis grossedentata used is sourced from Guangdong, Guangxi, Hunan, Hubei, or Jiangxi provinces, preferably from the spring or summer seasons in Zhangjiajie, Hunan province. The obtained dihydromyricetin extract contains ≥55% Dihydromyricetin.

Resveratrol extract is prepared by the following steps: Polygonum cuspidatum is used as the raw material, and ethanol with a concentration of 75% (six times the volume of the raw material) is used as the extraction solvent. The extraction is performed at a temperature of 70° C. to 75° C. for 1 hour, followed by ethanol recovery and spray drying of the extract solution to obtain the Resveratrol Extract, which contains ≥20% Resveratrol.

The vitamin C is produced by Zhengzhou Chengwang Chemical Co., Ltd., with a content of more than 95% Vitamin C.

The Agricultural Streptomycin Sulfate is produced by Chengdu Puhui Bioengineering Co., Ltd., with a content of more than 70% Streptomycin Sulfate.

### Example 1

Weigh 63% dihydromyricetin extract, 7% resveratrol extract, 15% Vitamin C, and 15% Agricultural streptomycin sulfate according to their mass percentages, place them in a mixing tank, stir evenly, and package in composite aluminum bags or cans to obtain the composition for promoting the early harvest of rice seeds (hereinafter referred to as the “rice seed harvest period regulator”).

### Example 2: Experiment on the Regulation of the Rice Seed Harvest Period by the Rice Seed Harvest Period Regulator

The rice seed harvest period regulator prepared in Example 1 is dissolved in water to form a ready-to-use solution with a concentration of 0.3%. After artificial pollination is completed during seed production, the regulator is sprayed once, using water as the control. As shown in Table 1, the regulator significantly increases the early germination rate and vigor of seeds from 10 to 24 days after pollination, effectively regulating the seed harvest period. Additionally, spraying the regulator also helps reduce the mold rate of seeds and improves the overall quality of seeds.

The germination vigor and germination rate of seeds sampled 10 days after pollination in the control group were 65.33% and 75.33%, respectively. The regulator-treated group had significantly higher germination vigor and germination rate, with values of 72.33% and 86%, respectively. According to national standards, hybrid rice seeds are considered qualified for sale when the germination rate reaches 80% or higher. In other words, under special or extreme circumstances, the seeds sprayed with the regulator can be harvested for field production purposes. In contrast, the germination rate of the control group samples did not meet national standards until 13 days after pollination (3 days later than the regulator-treated group). Additionally, 13 days after pollination, the germination rate of the control group was 92.33%, while the germination rate of the regulator-treated group was 93.33%. Therefore, the regulator not only regulates the harvest period of rice seeds but also improves the overall quality of the seeds.

TABLE 1
Effect of Rice Seed Harvest Period Regulator on Germination Vigor, Germination
Rate, and Mold Rate of Seeds at Different Periods After Pollination

| | | Germination | Germination | Mold |
|---|---|---|---|---|
| Treatment Period | Treatment | Vigor (%) | Rate (%) | Rate (%) |
| 10 Days After | CK | 65.33 ± 1.15c | 75.33 ± 1.12b | 1.00 ± 0.37a |
| Pollination | Regulator | 72.33 ± 0.75b | 86.00 ± 1.15a | 0.67 ± 0.12a |
| 13 Days After | CK | 87.33 ± 1.05b | 92.33 ± 0.25b | 1.67 ± 0.35a |
| Pollination | Regulator | 89.33 ± 0.95ab | 93.33 ± 0.25ab | 1.67 ± 0.50a |
| 16 Days After | CK | 89.00 ± 1.00a | 93.33 ± 0.25a | 2.00 ± 0.50ab |
| Pollination | Regulator | 88.67 ± 0.75a | 93.33 ± 0.75a | 3.00 ± 0.25a |
| 19 Days After | CK | 89.33 ± 0.75a | 92.00 ± 0.65a | 4.00 ± 0.75a |
| Pollination | Regulator | 89.33 ± 0.65a | 91.67 ± 0.55a | 4.00 ± 0.55a |
| 21 Days After | CK | 89.00 ± 1.20b | 91.67 ± 1.05b | 4.67 ± 0.75a |
| Pollination | Regulator | 94.33 ± 1.05a | 96.33 ± 1.15a | 2.00 ± 0.50b |

Note:
CK is the water control, and the regulator is the product from Example 1.

The test variety used was Longliangyou 534.

### Example 3: Simulated Regulation of the Rice Seed Harvest Period Using the Composition of the Present Invention for Promoting the Early Harvest of Rice Seeds

During the rice seed production process, depending on the rice variety, if it is expected that the seeds of a certain variety will mature and be ready for harvest 15 days after pollination, but weather forecasts indicate 5 consecutive days of adverse weather 15 days later, or if seed harvesting activities are expected to be busy 15 days later, the composition of the present invention for promoting the early harvest of rice seeds can be sprayed either immediately after artificial pollination or at different times after artificial pollination to promote early seed harvest, thereby reducing losses or avoiding peak farming seasons.

The above examples are the preferred embodiments of the present invention, but the implementation of the invention is not limited to the above examples. Any changes, modifications, substitutions, combinations, or simplifications made without departing from the spirit and principle of the present invention should be considered as equivalent replacements and fall within the protection scope of the present invention.

1. A composition for promoting the early harvest of rice seeds, characterized by being made from the following raw materials in mass percentage:
dihydromyricetin extract: 61.50% to 63.50%;
resveratrol extract: 6.00% to 9.00%;
vitamin C: 12.00% to 16.00%; and
agricultural streptomycin sulfate: 12.00% to 16.00%.

2. The composition for promoting the early harvest of rice seeds according to claim 1, characterized by being made from the following raw materials in mass percentage:
dihydromyricetin extract: 63.00%
resveratrol extract: 7.00%
vitamin C: 15.00%
agricultural streptomycin sulfate: 15.00%.

3. The composition for promoting the early harvest of rice seeds according to claim 1, characterized in that
the dihydromyricetin extract is obtained by extracting and purifying ampelopsis grossedentata, with a dihydromyricetin content of ≥55%;
the resveratrol extract is obtained by extracting and purifying grape skins and seeds, with a resveratrol content of ≥20%;
the vitamin C used contains more than 95% vitamin C; and
the agricultural streptomycin sulfate used contains more than 70% streptomycin sulfate.

4. The composition for promoting the early harvest of rice seeds according to claim 1, characterized in that the dihydromyricetin extract is prepared by the following steps: fresh stems and leaves of ampelopsis grossedentata are dried at a temperature of 35° C. to 45° C. to obtain dried ampelopsis grossedentata raw material; the dried raw material is extracted using an ethanol extraction method to obtain an extract solution, which is concentrated to 30% to 40% of its original volume, and the concentrated solution is placed in a −4° C. cold storage for 24 hours to allow precipitation, the precipitate at the bottom of the dried liquid is the Dihydromyricetin Extract, the ethanol extraction method uses a ratio of 1:10 to 12 between the dried raw material and ethanol, with an ethanol concentration of 85% to 95%, and the ampelopsis grossedentata is sourced from Guangdong, Guangxi, Hunan, Hubei, or Jiangxi provinces.

5. The composition for promoting the early harvest of rice seeds according to claim 4, characterized in that the ethanol concentration is 90%, the precipitate at the bottom of the dried liquid is dried in an oven at 90° C. to 95° C., and the ampelopsis grossedentata used is from the spring or summer seasons in Zhangjiajie, Hunan province.

6. The composition for promoting the early harvest of rice seeds according to claim 1, characterized in that the resveratrol extract is prepared by the following steps: Polygonum cuspidatum is used as the raw material, ethanol with a concentration of 75% and six times the volume of the raw material is used as the extraction solvent, the extraction is performed at a temperature of 70° C. to 75° C. for 1 hour, ethanol is recovered and the extract solution is spray-dried to obtain the resveratrol extract.

7. The method for preparing the composition for promoting the early harvest of rice seeds according to claim 1, characterized in comprising the following steps:
weighing the raw materials according to the proportions mentioned above;
placing them in a mixing tank;
stirring evenly, and then
packaging in composite aluminum bags or cans to obtain the composition for promoting the early harvest of rice seeds.

8. The application of the composition for promoting the early harvest of rice seeds according to claim 1 in promoting the early harvest of rice seeds, characterized in comprising the following steps: on the day of artificial pollination of rice seeds, the composition for promoting the early harvest of rice seeds is dissolved in water to form a ready-to-use solution with a concentration of 0.1% to 0.3%, and the solution is sprayed onto the rice panicles at a dosage of 50 kilograms per mu, with the number of sprays, 1 to 2 times, depending on the required seed maturity period.

9. The application according to claim 8, characterized in that if it rains within 24 hours after spraying, a re-spray is required.

10. The method for preparing the composition for promoting the early harvest of rice seeds according to claim 2, characterized in comprising the following steps:
weighing the raw materials according to the proportions mentioned above;
placing them in a mixing tank;
stirring evenly, and then
packaging in composite aluminum bags or cans to obtain the composition for promoting the early harvest of rice seeds.
